(19) United States
(12) Patent Application Publication
(10) Pub. No.: US 2022/0104563 A1
(43) Pub. Date: Apr. 7, 2022

(54) Face Covering with Adjustable Securement System

(71) Applicants: Angelyn McKelley, Roy, UT (US); Maurice McKelley, Roy, UT (US)

(72) Inventors: Angelyn McKelley, Roy, UT (US); Maurice McKelley, Roy, UT (US)

(21) Appl. No.: 17/495,987

(22) Filed: Oct. 7, 2021

Related U.S. Application Data
(60) Provisional application No. 63/088,483, filed on Oct. 7, 2020.

(51) Int. Cl. A41D 13/11; A62B 23/02; A62B 18/02

(52) U.S. Cl. CPC A41D 13/1161; A62B 18/025; A62B 23/025

(57) ABSTRACT

This present invention relates to a novel facemask with an adjustable securement system that is designed to cover a wearer's face, nose, and chin comfortably, and hang from the neck when not in use. The facemask system utilizes a unique combination of face covering tunnels, a single elastic cord and a cord lock to form one or two loops for securing the system around the wearer's head, and eliminates the issues and discomfort associated with typical facemask ear loops. In a further embodiment of the invention, the face covering portion of the novel facemask with an adjustable securement system is further comprised of an interior pocket for holding a replaceable scented or unscented air filter that increases the overall filtering efficiency of the system.

### CROSS-REFERENCE TO RELATED APPLICATION

The present application claims priority to, and the benefit of, U.S. Provisional Application No. 63/088,483, which was filed on Oct. 7, 2020 and is incorporated herein by reference in its entirety.

### FIELD OF THE INVENTION

The present invention relates generally to the field of personal protective equipment. More specifically, the present invention relates to a personal facemask designed to cover a user's face, nose and chin comfortably, and that is capable of being hung from the neck of the individual when not in use. The uniquely designed facemask features a novel band system that secures the mask to the face without the use of elastic ear bands which can cause irritation to the wearer. More particularly, the novel band system secures the facemask to the wearer's head via a cord and lock system. Additionally, the mask includes an interior pocket to allow the use of a removable filter, thereby increasing the efficiency of the facemask in filtering out harmful particulates. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, over the years epidemics and pandemics have affected a substantial number of individuals and have also been a cause of many deaths around the world. A pandemic is an epidemic of any disease that covers a large geographical region, and is caused in part by an exponential spread of virus, bacteria or other airborne pathogens. Various airborne viruses, bacteria, pathogens and diseases may be easily and quickly spread from one person to another when the person comes into contact with an infected person, or contaminated surface or area. When contracted, such diseases may lead the infected person to suffer from the contracted illness for a prolonged period of time, and could even lead to death in certain or critical cases.

To prevent the spread of infectious diseases, such as COVID-19 and other airborne infectious diseases, various precautions are being taken by people in the impacted areas. For example, various health care divisions or committees advise people to maintain a sterilized and/or sanitized environment in which manual cleaning of all the surfaces of homes, offices, schools, hospitals, restaurants or other places is required. However, manual cleaning is time consuming, tiring, ineffective and may leave some spots left uncleaned. Other challenges with manual cleaning and sanitization include missing areas, re-contamination from dirty sponges and mops, and improper use and mixing of antibacterial cleaning solutions. Other preventive measures include frequent washing of hands, and maintaining a safe distance from other people. However, as the ongoing COVID-19 pandemic has shown, these solutions are not always feasible and people may forget or be unable to wash their hands frequently or to maintain a safe distance from other people, thereby causing transmission of diseases among people with whom the individual comes into contact.

Most importantly, people have been advised and in some areas mandated to wear face-masks in order to prevent or at least slow the transmission of harmful pathogens, such as viruses, germs, bacteria and the like from person to person. Most facemasks cover the nasal and oral passages of the wearer, which creates a barrier against the transmission of germs, virus, bacteria or other harmful pathogens from an infected person or from the environment to the wearer of the facemask. Accordingly, various facemasks are available in the market today and are typically comprised of a mask body that covers the nose and mouth of the wearer, and a pair of elastic ear loops that are each attached to each side of the mask body and extend around the wearer's ears. However, the elastic ear loops of many facemasks have to be constantly adjusted over the wearer's ears, which tends to be uncomfortable for the wearer. The loops can also cause irritation or chafing to the wearer, as the loops tend to rub against the skin surrounding the wearer's ear. Individuals are less inclined to wear a facemask if it is ill-fitting and/or uncomfortable.

Additionally, when the mask is removed by the wearer, for example, to eat or consume a beverage, it is typically kept in a pocket, on a table, seat or other surfaces which potentially poses a threat of cross contamination to the mask from germs, bacteria, viruses and the like that may be present in such surfaces. Moreover, once the mask has been removed, the wearer oftentimes runs the risk of losing, misplacing, or leaving the mask behind, thereby requiring that the wearer go without the mask and the protection that it provides until a suitable replacement can be obtained.

Therefore, there exists a long felt need in the art for an improved facemask that is capable of effectively protecting the wearer from the transmission of air borne bacteria, germs, pathogens, viruses, diseases and the like, and that prevents the spread of infectious diseases. There is also a long felt need in the art for an improved facemask which enables the wearer to modify or adjust the facemask to make it more comfortable to wear, and so that is can be properly secured over the wearer's head and remains in proper position when worn. Moreover, there is a long felt need in the art for an improved facemask that can be worn for prolonged periods of time without irritating the skin of the wearer, and that can be hung around the wearer's neck when not in use so that the same does not get lost, misplaced, or become cross-contaminated. Finally, there is a long felt need in the art for an improved facemask with enhanced pathogen filtering capabilities that is relatively inexpensive to manufacture, and is both safe and easy to wear.

The subject matter disclosed and claimed herein, in one embodiment thereof, comprises a novel facemask for covering the nose, mouth, and chin area of a wearer. The novel facemask comprises a cloth or other filtering substrate that is sized and configured to fit over a portion of the wearer's face, an elastic cord for securing the facemask to the wearer's head, and comprising two ends and a cord lock comprising two lockable openings therein. More specifically, the facemask cloth has stitched column-like openings positioned along each of its longitudinal ends, wherein the column-like openings are stitched approximately 0.5″ away from the edge of the facemask cloth to create a passageway through which the elastic cord may pass. In particular, the elastic cord is looped through each of the column-like openings to form an upper loop and a lower loop, and each lockable opening of the cord lock receives one end of the elastic cord to create an adjustable securing mechanism for the facemask. In a further embodiment, the facemask portion of the invention further comprises a pocket and an associated and replaceable filter for providing the wearer with enhanced filtering capabilities.

In this manner, the novel face covering with adjustable securement system of the present invention accomplishes all of the forgoing objectives, and provides a relatively safe, easy, convenient and cost-effective solution to covering the oral and nasal passageways of the wearer, thereby acting as a barrier for the transmission of harmful pathogens such as germs, virus, bacteria, and the like. The face covering with adjustable securement system of the present invention is also user friendly, inasmuch as the facemask is easily adjustable and comfortable to wear for prolonged periods of time without causing irritation to the wearer. The face covering with adjustable securement system of the present invention also provides enhanced filtering capabilities, and is relatively inexpensive to procure.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

As noted above, the subject matter disclosed and claimed herein, in one embodiment thereof, comprises a novel facemask system for covering the nose, mouth, and chin area of the wearer. More specifically, the facemask system comprises a filtering substrate, an elongated and elastic cord having two opposing ends, and a cord lock with two separate lockable openings therein. The filtering substrate has a continuous lateral opening sewn into each of its longitudinal ends, wherein the continuous lateral opening is positioned approximately 0.5″ away from the longitudinal edges of the filtering substrate. The elongated elastic cord is then looped through each of the continuous lateral openings to form an upper loop and a lower loop, and each of the lockable openings in the cord lock receives a respective end of the elastic cord to create an adjustable securing mechanism for the novel facemask.

In a further embodiment of the present invention, a face covering in the form of a facemask with an adjustable securement system is disclosed. The facemask comprised two sewn columns along the facemask sides, with each column having an upper opening and a lower opening. A thin 5/32″ maritime cord is fed through each of the two sewn columns to form an upper loop between the two upper openings to secure the facemask onto the head of a wearer, and a lower loop between the two lower openings to also assist in securing the facemask onto the head of the wearer. Once the upper and lower loops have been formed, each of the two ends of the cord may be fed through a respective opening in a cord lock, thereby allowing the wearer to properly adjust the size of each of the upper and lower loops to ensure a snug, yet comfortable fit and to prevent slippage.

The subject matter disclosed and claimed herein, in another embodiment thereof, comprises a unique facemask to cover the nose, mouth, and chin area of a wearer. The facemask comprises a cloth or other filtering media, an elastic cord, and a two hole cord lock. The facemask cloth has sewn columns along its of its longitudinal ends, spaced approximately 0.5″ away from each of the longitudinal ends of the facemask cloth or media. Each of the sewn columns form tunnels having openings at each of the ends of each of the tunnels. The elastic cord is then looped through the tunnel from a lower opening of the left column and looped out from the upper opening of the left column. The looped out elastic cord from the upper opening of the left column is then looped into the upper opening of a right column to form an upper loop. Once looped into the upper opening in the right column, the cord extends downwardly through the tunnel where it exits the lower opening and passes through one of the openings or holes in the two-hold cord lock. Similarly, the other end of the elastic cord is passed through the other opening or hole of the two-hole cord lock, thereby creating a non-slipping lower loop for securing the facemask to the head of a wearer.

In a further embodiment of the present invention, a method for manufacturing a facemask with an adjustable securement system is disclosed. The method comprises the steps of cutting a square piece of fabric or filter media into a facemask shape to cover a nose, mouth, and chin area of the wearer. Next, each longitudinal end of the facemask cloth is stitched to form a continuous column at each end, with each column or tunnel having openings on both ends thereof for receiving the elastic cord. One end of an elastic cord is inserted into one of the columns or tunnels through a lower hole while the other end is free. The inserted end of the elastic cord is looped out from an upper hole of the same column, and is then inserted into an upper hole of the other column or tunnel thus forming an upper loop, taking out the end from the lower hole of the other column, and passing both the ends of the elastic cord through a double hole cord lock to complete the adjustable securing mechanism of the facemask.

The facemask of the present invention is particularly advantageous because an individual can wear the facemask loosely around his or her neck when the mask is not being worn over the face. The wearer may also adjust the tension of the bands for fit and comfort. In a further embodiment, the facemask further comprises an interior pocket into which a replaceable scented or unscented filter may be inserted to further enhance the filtering capabilities of the facemask. The unique band system of the facemask of the present invention secures the mask to the face of the wearer without the use of elastic ear bands, and can be worn for longer periods of time even while wearing spectacles, goggles, face shields, earphones or the like. Furthermore, the facemask is eco-friendly, cost-effective and a wearer does not need to remove and place it on a nearby and potentially contaminated surface while not wearing the mask over the face. The facemask may also comprise a “butterfly” wing for comfortably covering of the nose and chin of the wearer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of the face covering with adjustable securement mechanism of the present invention being worn by a wearer in accordance with the disclosed architecture;

FIG. 2 illustrates a rear perspective view of one potential embodiment of the face covering with adjustable securement mechanism of the present invention being worn by a wearer in accordance with the disclosed architecture;

FIG. 3 illustrates a side perspective view of one potential embodiment of the face covering with adjustable securement mechanism of the present invention being worn by a wearer in accordance with the disclosed architecture;

FIG. 4 illustrates a side perspective view of an alternative potential embodiment of the face covering with adjustable securement mechanism of the present invention being worn by a wearer in accordance with the disclosed architecture, wherein only the lower loop is being used to secure the face covering to the head of the wearer;

FIG. 5 illustrates a front perspective view of one potential embodiment of the face covering with adjustable securement mechanism of the present invention being utilized by a wearer in accordance with the disclosed architecture, wherein the covering remains secured to the wearer but is not being worn over the face of the wearer;

FIG. 6 illustrates a perspective view of one potential embodiment of the securement mechanism of the present invention in accordance with the disclosed architecture, wherein the securement mechanism is unassembled;

FIG. 7 illustrates a perspective view of one potential embodiment of the face covering with adjustable securement mechanism of the present invention in accordance with the disclosed architecture ,wherein the face covering and securement mechanism is unassembled; and

FIG. 8 shows a side elevational view of one potential embodiment of the first and second layers of the face covering stitched together and the related unstitched areas that form the continuous tunnels through which an elastic cord may be inserted in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved facemask that is capable of effectively protecting the wearer from the transmission of airborne bacteria, germs, pathogens, viruses, diseases and the like, and that prevents the spread of infectious diseases. There is also a long felt need in the art for an improved facemask that can be worn for prolonged periods of time without irritating the skin of the wearer, and that can be hung around the wearer's neck when not in use so that the same does not get lost, misplaced, or become cross contaminated. Moreover, there is a long felt need in the art for an improved facemask which enables the wearer to modify or adjust the facemask to make it more comfortable to wear, and so that is can be properly secured over the wearer's head and remain in proper position when worn. Finally, there is a long felt need in the art for an improved facemask with enhanced pathogen filtering capabilities that is relatively inexpensive to manufacture, and is both safe and easy to wear.

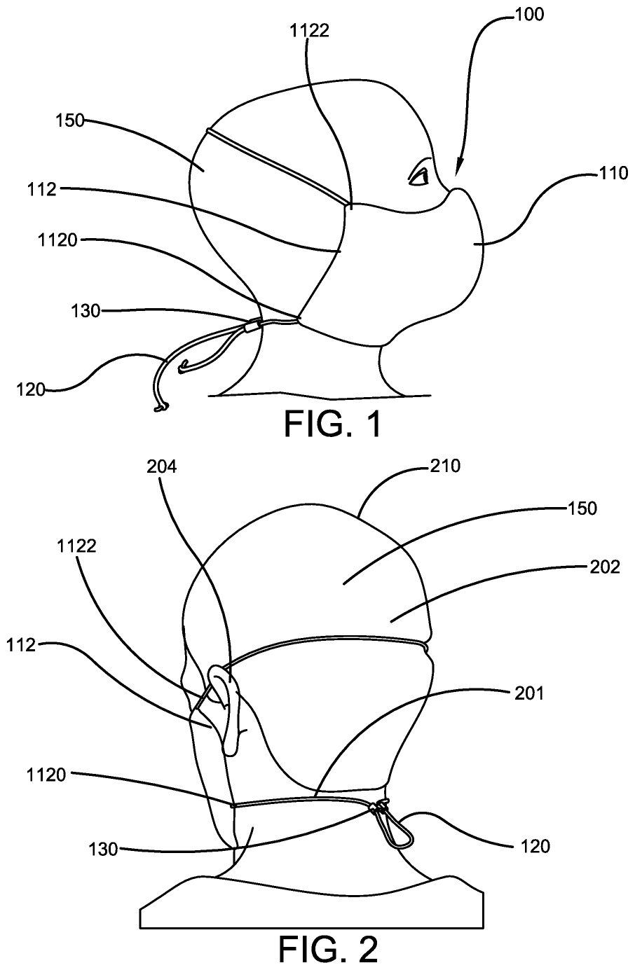

Referring initially to the drawings, FIG. 1 illustrates a side perspective view of one potential embodiment of the face covering with adjustable securement system 100 of the present invention being worn by a wearer 210 in accordance with the disclosed architecture. More specifically, the facemask with adjustable securing system 100 is a novel facemask used to protect the wearer 210 from transmitting or receiving harmful airborne germs, bacteria, pathogens, diseases, microbes and the like. The facemask with adjustable securing mechanism 100 preferably has a contoured design, which is sized and configured to cover a wearer's face, nose, and chin area comfortably. The system 100 comprises a facemask cloth or other filter media 110, an elastic strap or cord 120, and a cord lock 130. The elastic strap 120 and cord lock 130 are used to secure the facemask cloth or other filter media 110 to the wearer's head 150, as explained more fully below.

The facemask cloth 110 is a generally rectangular or contoured length of fabric cloth or filter media that may be positioned across the wearer's face so as to cover the wearer's nose, mouth and chin areas and protect the oral and nasal passageways of the wearer from harmful pathogens, diseases, viruses, germs, microbes and the like. Similarly, to the extent that the wearer 210 may be infected or otherwise sick, the facemask cloth 110 prevents the wearer from infecting others by filtering out any of the harmful pathogens, diseases, viruses, germs, microbes and the like that may be expelled from the oral and nasal passageways of the wearer 210.

The facemask cloth 110 may have any fanciful design, color, logo or picture that suits the needs or preferences of the wearer 202. The facemask cloth 110 may also be comprised from natural, synthetic, renewable, and/or recycled fibers, provided that the same are capable of filtering approximately 95% of all harmful pathogens, diseases, viruses, germs, microbes and the like that may come into contact with the facemask cloth or other filter media 110. The natural fibers may include, but are not limited to, cotton, hemp, silk, cashmere, alpaca, and combinations thereof, wherein the synthetic fibers may include, but are not limited to, polyester, polyethylene, polystyrene, and the like. Similarly, the renewable and recycled fibers and fabrics can be made from fishing nets, polyethylene, bamboo, and other combinations of renewable, recyclable, natural and synthetic fibers.

As best shown in FIG. 1, in one embodiment of the present invention, the facemask cloth 110 may have a filter pocket 115 sewn into an interior face (i.e., the side of the cloth 110 that is immediately adjacent to the wearer's face) of the facemask cloth 110 that is capable of receiving an air filter 116 to further increase the filtering efficiency of the face covering with adjustable securement system 100. The pocket 115 and accompanying filter 116 should be large enough in size, shape and configuration to cover both the oral and nasal passageways of the wearer 210. Further, the replaceable filter 116 may be unscented or scented to, for example, provide the wearer with a pleasant fragrance as he or she breathes in air through the facemask cloth 110 and the insertable filter 116.

The elastic cord or strap 120 is an elongated rope like member having opposing ends 1201, 1202. In a preferred embodiment of the present invention, the elastic strap 120 is a relatively thin (i.e. approximately 5/32″ in diameter) maritime cord comprised of a synthetic material that is also waterproof, though it is contemplated that other materials, as well as sizes, of strap 120 may also be used provided that they are capable of corresponding with the facemask cloth 110 and the cord lock 130, as described more fully below.

As stated above, the strap/cord 120 is used in conjunction with cord lock 130 to secure the facemask cloth/media 110 to the wearer's head 150. More specifically, the facemask cloth 110 has sewn columns or tunnels 112 parallel to each of the longitudinal edges of the facemask cloth 110, which receive the elastic strap 120. Each of the two sewn columns or tunnels 112 has a bottom opening 1120 from which the sewn or formed column or tunnel 112 receives a first end of the elastic strap 120 and a top opening 1122 through which the received end of the elastic strap exits the tunnel 112. The respective end 1201 or 1202 of the elastic strap 120 that comes out of the top opening 1122 is then inserted into a similar top opening 1122 of a sewn or formed column 112 on the other longitudinal end of the facemask cloth 110 to make an upper loop 202. The same end 1201 or 1202 then travels downwardly through the second tunnel 112 and exits the bottom opening 1120 thereof, wherein both ends 1201, 1202 are then inserted into a pair of openings 1301, 1302 in the cord lock 130 to form a second or lower loop 210, as explained more fully below.

The face covering with adjustable securement system 100 of the present invention uses a single strand of elastic material to hold the facemask cloth or covering to the head of the wearer 210 (via one or two loops, as explained more fully below), as opposed to the two separate strands of material used for conventional facemasks. The facemask with an adjustable securement system 100 is useful for individuals who wear glasses, face shields or hearing aids, and who cannot otherwise wear a conventional facemask with ear loops. The elastic strap 120 keeps the facemask 100 tight and close to the face of the wearer 210, and the facemask system 100 takes the pressure off of the ears and nose of the wearer, while also reducing fogging up of the lenses of the glasses or face shield when breathing.

The facemask system 100 is easy to wear, as a wearer 210 need only pull the elastic strap 120 through cord lock 130 for a custom fit behind the wearer's head 150. As stated above, the facemask cloth 110 may also be stitched so as to be contoured, such that is has a flexible nose arch and a comfortable pouch-like chin cradle. Further, the facemask cloth 110 is lightweight and breathable, but effective at filtering out approximately 95% of all harmful pathogens, diseases, viruses, germs, microbes and the like. Accordingly, the material selected for the facemask cloth/filter media 110 should after weaving ideally have a pore size of between 20 and 150 microns. The weaving may be performed by spin bonding multiple layers of fibers, one on top of the other, to create a tortuous path making it difficult if not impossible for bacteria, germs, or other pathogens to pass through. Providing multiple layers of fabric has generally been shown to be more effective than a single layer of material.

FIG. 2 illustrates a rear perspective view of one potential embodiment of the face covering with adjustable securement mechanism of the present invention being worn by a wearer 210 in accordance with the disclosed architecture. More specifically, when worn, the facemask system does not require ear loops, and instead relies upon the elastic strap 120 and cord lock 130 to adjustably attach itself to the head 150 of the wearer. When the facemask system 100 is worn, two adjustable securing loops, namely an upper adjustable securing loop 202 and a lower adjustable securing loop 201, formed from the single elastic strap 120 secure the facemask system 100 on the head 150 of the wearer 210. More specifically, the upper adjustable securing loop 202 and the lower adjustable securing loop 201 are formed from the single elastic strap 120 by inserting a first end 1201 of the elastic strap 120 into a sewn column or woven tunnels 112 on one end of the facemask 100 and into a similar sewn column or woven tunnel 112 on the opposite end of the facemask cloth 110. The openings 1120, 1122 are used for receiving and exiting the first end 1201 of the elastic strap 120 to form the upper adjustable securing band 202 and the lower adjustable securing band 201.

Further, the tension of each of the upper securing loop 202 and the lower securing loop 201 may be adjusted for fit and comfort by using the sliding cord lock 130. When the facemask system 100 is worn by the wearer 210, the upper adjustable securing loop 202 is typically positioned around the head 150 of the wearer 210 just above the height of the ears 204 of the wearer 210, and the lower adjustable securing loop 201 is wrapped around the head 150 of the wearer 210 just below the lower level of the ears 204. Accordingly, the facemask system 100 of the present invention eliminates the tension and chafing around the wearer's ears that typically accompanies the use of ear looped facemasks by, for example, healthcare workers, grocery store workers, educators and all others who must wear a facemask for extended or prolonged periods of time.

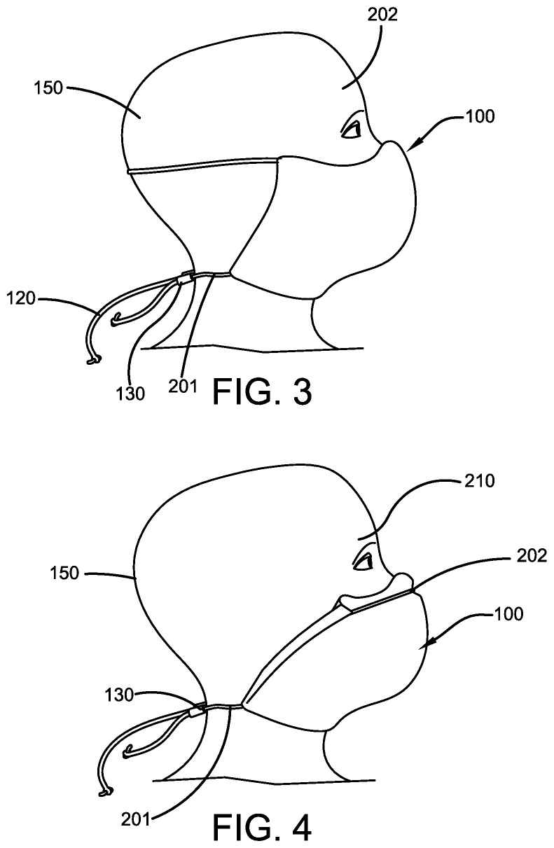

FIG. 3 illustrates a side perspective view of one potential embodiment of the face covering with adjustable securement mechanism 100 of the present invention being worn by a wearer 210 in accordance with the disclosed architecture. In this embodiment, the upper adjustable securing band 202 is adjusted to become relatively horizontal, and the lower adjustable securing band 201 is worn around the neck area of the wearer 210. Nonetheless, each of the upper securing band 202 and the lower securing band 201 are adjustable and secured using the cord lock 130, wherein the single elastic cord/strap 120 passes through each of the openings 1301, 1302 in the cord lock 130.

FIG. 4 illustrates a side perspective view of an alternative potential embodiment of the face covering with adjustable securement mechanism 100 of the present invention being worn by a wearer 210 in accordance with the disclosed architecture, wherein only the lower securing loop 210 is being used to secure the face covering 110 to the head 150 of the wearer 210. More specifically, while the facemask system 100 preferably relies upon the presence of both an upper securing band/loop 202 and a lower securing band/loop 20, the facemask system 100 can also be worn by the wearer 210 by securing the face covering 110 only with the lower adjustable securing band 201. Nonetheless, even in this embodiment, the facemask system 100 is adjustably secured to the head 150 of the wearer 210 without the need for problematic ear loops and continues to cover the nose, mouth and chin area of the wearer 210.

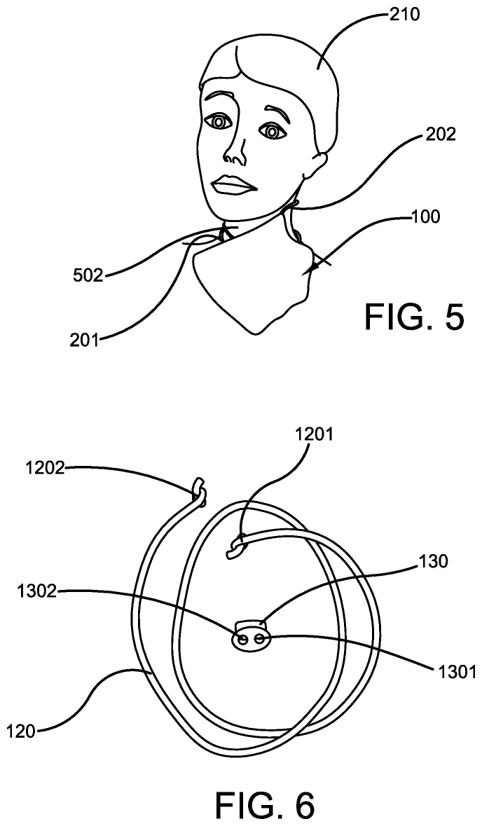

FIG. 5 illustrates a front perspective view of one potential embodiment of the face covering with adjustable securement mechanism 100 of the present invention being utilized by a wearer 210 in accordance with the disclosed architecture, wherein the face covering 110 remains secured to the wearer 210 but is not being worn over the face of the wearer 210. More specifically, when the wearer 210 is alone or otherwise does not want to wear a facemask, for example, when eating or drinking, the facemask system 100 can be worn or hung around the neck 502 by loosening the bands/loops 201 and 202 using the cord lock 130. This eliminates the need for the wearer 210 to completely remove the facemask system 100 when it is not temporarily needed, wherein it could become lost, misplaced or contaminated once it touches a contaminated surface, such as a countertop, table-top or the like.

FIG. 6 illustrates a perspective view of one potential embodiment of the securement mechanism of the present invention in accordance with the disclosed architecture, wherein the securement mechanism is in an unassembled state. More specifically, the elastic cord 120 is a single cord comprised of the two opposing ends 1201, 1202, and the cord lock 130 is preferably a double hole toggle cord lock comprised of a durable material, such as silicon or plastic. The elastic cord/band 120 may be available in multiple colors and be comprised of Spandex®, polyester or any other similar material that is elastic, eco-friendly and has high tensile strength. The elastic cord or band 120 can have a cross section that is flat, square, round or any other shape, and preferably has a width or diameter (depending on its cross-section) that is in the range of between 2 mm and 6 mm. Further, the elastic cord 120 is preferably breathable and has a relatively soft texture so as to not irritate the skin of the wearer 210. The elastic cord/band 120 is preferably in the range of 40″ and 50″ in length, but can be longer or shorter depending on the wants and needs of the wearer 210.

Additionally, the presence of the adjustable cord lock 130 makes it easy for the wearer 210 to adjust the size of the bands/loops 201 and 202 as per the wants and needs of the wearer 210. The two holes/openings 1301, 1302 in the cord lock preferably have a diameter in the range of 3 mm-8 mm to receive and stop various diameters of the elastic cord 120. Further, the lock cord 130 can work with any type of elastic or other cord and is not limited to paracord, elastic cording and leather cording. The cord lock 130 secures the two ends 1201, 1202 of the elastic cord 120, and prevents slippage therebetween. Each of the two ends of the elastic cord 120 may be passed through a respective opening/hole 1301, 1302 to form the lower loop 201.

The cord lock 130 may have circular or oval holes which act as stoppers and have a spring loaded design which gives a firm grip and helps to stop the cord or drawstrings from slipping. In one embodiment, the cord lock 130 may have dimensions of 2.3×2×0.7 cm (LWH).

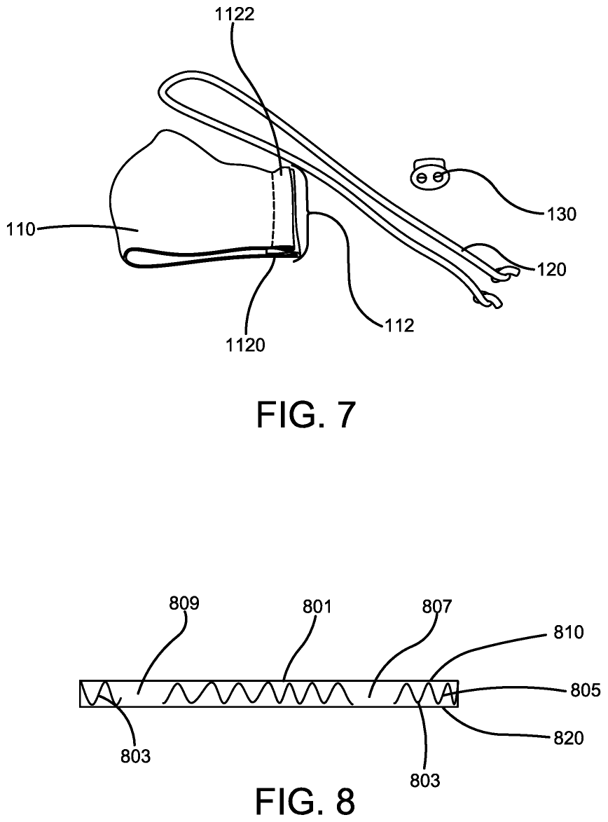

FIG. 7 illustrates a perspective view of one potential embodiment of the face covering with adjustable securement mechanism 100 of the present invention in accordance with the disclosed architecture ,wherein the face covering and securement mechanism is in an unassembled state. As previously stated, the face covering with adjustable securement mechanism 100 is preferably comprised of a face covering 110, a single cord or strap 120 and a cord lock 130.

During production, the facemask cloth 110 may be cut into a facemask shape of various sizes to cover the nose, mouth and chin area of the wearer 210, and is preferably comprised of a first and second layer sewn or woven together. Further, each longitudinal end or side of the facemask cloth 110 is sewn or formed to create a column or tunnel 112 at each end or side having holes at either end of the column or tunnel 112 to receive/discharge the elastic cord 120. Then, one end 1201 of the elastic cord 120 is inserted into one of the columns or tunnels 112 through the lower hole 1120 and is taken out from the upper hole 1122. The end 1201 is then inserted into a similar upper hole 1122 of the other column or tunnel 112 and is taken out from the lower hole 1120 of the other column 112. Then, each of the ends 1201, 1202 of the elastic cord 120 is passed through the respective openings 1301, 1302 in the cord lock 130 to form the lower securing loop 201 and complete the adjustable securing mechanism of the facemask 100.

The face covering portion 110 of the mask system 100 may be manufactured in various sizes, styles and fabrics. For example, in one embodiment, the size of an adult facemask 110 may be 7.2″ W×5.2″ H, wherein the width refers to the span across the face of the wearer (e.g., ear to ear) and the height refers to the vertical span of the wearer's face (e.g., from the bridge of the nose to just beneath the chin). In another embodiment, the size of an adult facemask 100 may be 7.5″ W×5.3″ H. The facemask system 100 may also be manufactured in sizes that are more suitable for infants, children and younger adults.

FIG. 8 shows a side elevational view of one potential embodiment of the first and second layers of the face covering stitched together and the related unstitched areas that form the continuous tunnels through which the elastic cord 120 may be inserted in accordance with the disclosed architecture. More specifically, a first cloth/media layer 810 is woven to a second cloth/media layer 820, as indicated by weaving 805. The weaving 805 is discontinuous, and secures a central area 801 and end areas 803, leaving open or unwoven areas 807 and 809 to create tunnels or channels in the woven structure. In this way, the first layer 810 does not have any stitching, which may rub against the face of the wearer 210, and the overall strength between the two layers 810, 820 created by the weaving is sufficient to hold the cord 120 in proper position during use.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “facemask with adjustable securing mechanism”, “face coverings with adjustable secure system”, and “facemask” are interchangeable and refer to the facemask with adjustable securing mechanism 100 of the present invention.

Notwithstanding the forgoing, the facemask with adjustable securing mechanism 100 of the present invention can be of any suitable size and configuration as is known in the art without affecting the overall concept of the invention, provided that it accomplishes the above stated objectives. One of ordinary skill in the art will appreciate that the size, configuration and material of the facemask with adjustable securing mechanism 100 as shown in the FIGS. are for illustrative purposes only, and that many other sizes and shapes of the facemask with adjustable securing mechanism 100 are well within the scope of the present disclosure. Although the dimensions of the facemask with adjustable securing mechanism 100 are important design parameters for user convenience, the facemask with adjustable securing mechanism 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personal protective equipment comprising:
a filtering media having at least a first layer and a second layer, wherein the filtering media is sized and configured to fit over a nasal passageway and an oral passageway of an individual;
a first tunnel formed on a first side edge of the filtering media;
a second tunnel formed on a second side edge of the filtering media;
a single cord positioned in each of the first tunnel and the second tunnel; and
a cord lock repositionable along each of a first end of the single cord and a second end of the single cord.

2. The personal protective equipment as recited in claim 1, wherein the filtering media has a pore size ranging between 20 and 150 microns.

3. The personal protective equipment as recited in claim 1, wherein the filtering media is comprised of a material selected from a group consisting of a natural material, a synthetic material, a renewable material, a recycled material or a combination thereof.

4. The personal protective equipment as recited in claim 3, wherein the natural material is comprised of a cotton, a hemp, a silk, a cashmere, an alpaca or a combinations thereof.

5. The personal protective equipment as recited in claim 3, wherein the synthetic material is comprised of a polyethylene, a polystyrene or a combination thereof.

6. The personal protective equipment as recited in claim 1, wherein the filtering media is further comprised of a pocket and a removable filter positioned in the pocket.

7. The personal protective equipment as recited in claim 1, wherein the removable filter is a scented filter.

8. The personal protective equipment as recited in claim 1, wherein each of the first tunnel and the second tunnel is formed by one of a sewing or a weaving.

9. The personal protective equipment as recited in claim 1, wherein an exterior surface of the filtering media may comprise a logo, an indicia, a trademark, a geometric pattern, a customizable color, a font, an embroidery, a prints, an image or a combination thereof.

10. The personal protective equipment as recited in claim 1, wherein the single cord is comprised of an elastic material.

11. The personal protective equipment as recited in claim 1, wherein the first tunnel is positioned within a half inch of the first side edge of the filtering media and the second tunnel is positioned within a half inch of the second side edge of the filtering media.

12. The personal protective equipment as recited in claim 1, wherein each of the first tunnel and the second tunnel is formed by weaving a discontinuous pattern.

13. The personal protective equipment as recited in claim 12, wherein the discontinuous pattern includes a woven area and an unwoven area.

14. A facemask system comprising;
a face covering comprised of a first layer of material and a second layer of material;
a single elastic cord; and
a cord lock, wherein the face covering further comprises a first column positioned on a first edge of the face covering and a second column positioned on a second edge of the face covering, and further wherein each of the first and second columns are formed by one of a sewing or a weaving.

15. The facemask system as recited in claim 14, wherein the single elastic cord passes completely through each of first and second columns and through a pair of separate openings in the cord lock.

16. The facemask system as recited in claim 14, wherein each of the first and second layers of material has a pore size of between 20 and 150 microns.

17. The facemask system as recited in claim 14, wherein single elastic cord forms a first loop and a second loop and further wherein ach of the first and second loops encircle a head of a wearer of the face mask system.

18. An adjustable facemask system comprising:
a cloth covering sized and configured to fit over a nose and a mouth region of an individual, wherein the cloth covering comprised a first layer and a second layer secured together by one of a sewing or a weaving;
a first tunnel and a second tunnel formed into the cloth covering by one of the sewing or the weaving;
a single elastic cord passing through each of the first and second tunnels to form a first loop and a second loop; and
a cord lock having a first opening and a second opening.

19. The adjustable facemask system of claim 18, wherein the single elastic cord passes through each of the first and second openings of the cord lock, and further wherein the cloth covering has a pore size of between 20 and 150 microns.

20. The adjustable facemask system of claim 18, wherein the weaving is performed in a discontinuous manner to create a woven area and an unwoven area.
